(19) United States
(12) Patent Application Publication
(10) Pub. No.: US 2009/0090894 A1
(43) Pub. Date: Apr. 9, 2009

(54) SEPARATION AND EXTRACTION SYSTEM

(76) Inventors: Bin Wang, Urbana, IL (US); Hao Feng, Urbana, IL (US); Thaddeus Ezeji, Wooster, OH (US); Hans Blaschek, Champaign, IL (US)

Correspondence Address: EVAN LAW GROUP LLC, 600 WEST JACKSON BLVD., SUITE 625, CHICAGO, IL, 60661, US

(21) Appl. No.: 11/868,355

(22) Filed: Oct. 5, 2007

(51) Int. Cl. B01D 11/04

(52) U.S. Cl. 252/364

(57) ABSTRACT

Extraction systems comprising acetonitrile, water, and a saccharide selected from the group consisting of a monosaccharide, an oligosaccharide, and mixtures thereof. The systems comprise a first phase and a second phase, and the concentration of the saccharide is at least 0.5 weight/volume %.

### BACKGROUND

Liquid-liquid extraction, also known as solvent extraction, is an effective method of separating compounds having different solubilities in two immiscible liquids, usually water and an organic solvent. This method has been widely employed in hydrometallurgical, nuclear, pharmaceutical, and food industries to separate target components from liquid mixtures [18, 20].

A drawback of using these water-immiscible solvents is that because of their low dielectric constants, they are poor at the extraction of highly charged solutes except nitrobenzene [1, 12]. This is particularly true for many highly water soluble pharmaceuticals. Because of their charged acid or alkaline moieties, many highly water soluble pharmaceuticals can be extracted by traditional liquid-liquid extraction with water-immiscible solvents only at very low or very high pH. Accordingly, it is often necessary to accompany liquid-liquid extractions by dosing fermentation broths with acids and/or alkaline compounds. Unfortunately, such dosing usually results in yield losses and product emulsification, as many pharmaceuticals are very unstable in low or high pH aqueous environments and tend to be quickly degraded by acid or alkaline hydrolysis [18, 36, 37, 38, and 40].

Since the addition of an inorganic salt into a mixture of water and a water-miscible organic solvent causes separation of the solvent from the mixture and formation of a two-phase system, many studies on the dehydration of organic solvents by salting-out have been undertaken [2, 3, 4]. Frankforter and Fray [3] first investigated ternary systems of water-miscible organic liquids, salts, and water. Their findings were that potassium carbonate (K₂CO₃) was the only salt that would cause salting-out of methanol, while several salts would cause the salting-out of ethanol. The dehydration of acetone was very similar to that of alcohol and ether. In most cases the dehydration of organic liquids is accompanied by the formation of two definite layers [2], one organic and the other aqueous.

In the effort to develop new extraction methods to meet the diverse needs for separation, numerous experiments have been conducted over decades to explore the potential of utilizing this “salting-out” phenomenon in extraction applications. The high polarity water-miscible solvents used in salting-out extraction systems have been investigated for extraction or concentration of metal-chelates, ion-pairs, and organic materials, particularly ones that cannot be extracted by conventional liquid-liquid extraction methods [1, 11, 12, 16, 17, 22]. Ethanol-water-ammonium sulfate and similar systems have been tested for extraction or concentration of volatile flavors, bitter flavors, tannins, and pigments from sugars or acids in wines and similar products [14].

Unfortunately, salting-out usually occurs at high salt concentrations. Lu et al. [10] studied the separation of tertiary butanol from its aqueous solution for commercial production, selecting potassium fluoride (KF) as a salting-out agent. A twice salting-out process was designed for the reutilization of KF aqueous solutions, and a final concentration of 96% tertiary butanol was achieved. However, the total corresponding KF consumption was at least 0.43 g of KF per gram of solution. This high inorganic salt concentration in salting-out and the consequential equipment corrosion and fouling concerns have been important considerations in potential commercial applications of such extraction methods [9, 21].

Acetonitrile (ACN) is a polar solvent with a high dielectric constant that has a strong affinity for highly charged compounds, such as metal chelates, ion pairs and organic solutes. ACN is miscible with water in all proportions [19]. The separation of ACN from aqueous solutions is of particular interest because of significant demand for ACN as a solvent and starting material for the syntheses of many chemicals [23]. However, ACN like many other organic solvents forms an azeotrope with water, which will prevent the collection of pure ACN by normal distillation. The azeotrope boils at 76° C. and is composed of 86% ACN and 14% water, so there is no possibility of obtaining ACN of a purity above 86%, unless costly multiple extractive techniques are used [24-30].

Salting-out of ACN can be carried out using a number of salts. For example, Legget et al. [8] compared the efficiency of salting-out ACN/water extraction with that of traditional solvent extraction. They obtained the two phases by adding 130 g of NaCl into a mixture of 400 ml water and 100 ml ACN. Based on the extraction of 14 polar organic solutes, they found improved solute recoveries with the salting-out ACN/water system. Even methylene chloride, one of the most polar solvents generally used for extraction of analytes from water, produced only 23.6%, 59.6% and 88.1% recovery rate for octahydro-1,3,5,7-tetranitro-1,3,5,7-tetracocine, hexahydro-1,3,5-trinitro-1,3,5-triazine, and 1,3-dinitrobenzene extraction, respectively, while the corresponding recovery rate with salting-out of ACN/water reached 95.6%, 93.9%, 96.5%. Salting-out of ACN/water was also studied to extract both polar and non-polar pesticide residues from non-fatty foods [13].

Jones et al. [5] used saturated salts solution of KF, NaCl, LiCl, NaHCO₃, and NH₄AcO for salting-out of ACN/water mixture at room temperature, and no phase separation was observed in the NaHCO₃/ACN/water system. When a number of salts were used to investigate the salting-out extraction efficiencies of phenol, catechol, resorcinol and hydroquinone, KF in ACN/water extraction systems was found to convert hydroquinone to quinine [5]. Also, the presence of metal ions in solvent extraction systems has limited their use in certain applications, such as the manufacture pharmaceuticals, as metal ions usually promote degradation of pharmaceutical compounds [18].

### SUMMARY

In a first embodiment, the invention provides extraction systems comprising acetonitrile, water, and a saccharide selected from the group consisting of a monosaccharide, an oligosaccharide, and mixtures thereof. The systems comprise a first phase and a second phase, and the concentration of the saccharide is at least 0.5 weight/volume %.

In a second embodiment, the invention provides methods of separating acetonitrile from water, comprising adding a saccharide to a mixture comprising acetonitrile and water. The saccharide is selected from the group consisting of a monosaccharide, an oligosaccharide, and mixtures thereof, and the concentration of the saccharide is at least 0.5 weight/volume %.

In a third embodiment, the invention provides methods of extracting a compound from an aqueous solution, comprising adding acetonitrile and a saccharide to the solution. The saccharide is selected from the group consisting of a monosaccharide, an oligosaccharide and mixtures thereof, and the concentration of the saccharide is at least 0.5 weight/volume %.

In a fourth embodiment, the invention provides extraction systems comprising acetonitrile, water, optionally salt, and a saccharide selected from the group consisting of a monosaccharide, an oligosaccharide, and mixtures thereof. The systems comprise a first phase and a second phase, and the amount of the salt is insufficient to cause phase separation of a composition consisting of the acetonitrile, the water and the salt.

In a fifth embodiment, the invention provides methods of separating acetonitrile from water, comprising adding a saccharide to a mixture comprising acetonitrile, water and optionally salt. The saccharide is selected from the group consisting of a monosaccharide, an oligosaccharide, and mixtures thereof, and the amount of the salt is insufficient to cause phase separation of a composition consisting of the acetonitrile, the water and the salt.

In a sixth embodiment, the invention provides methods of extracting a compound from an aqueous solution optionally comprising salt, the methods comprising: adding acetonitrile and a saccharide to the solution. The saccharide is selected from the group consisting of a monosaccharide, an oligosaccharide, and mixtures thereof, and the amount of the salt is insufficient to cause phase separation of a composition consisting of the acetonitrile, the water and the salt.

### BRIEF DESCRIPTION OF THE DRAWINGS

FIG. 1 illustrates the molecular structures of certain saccharides and acetonitrile.

FIG. 2 illustrates the distribution of saccharides in a sugaring-out two-phase system with glucose (A), xylose (B), arabinose (C), fructose (D), sucrose (E), and glucose+xylose (F).

FIG. 3 illustrates the extraction of Sudan I in a sugaring-out two-phase separation system.

FIG. 4 illustrates the Sudan I extraction rates in a sugaring-out two-phase system at different glucose concentrations.

FIG. 5 illustrates the distribution of syringic acid (A,B) and furfural (C,D) in sugaring-out two phase systems with glucose (A,C) and xylose (B,D).

FIG. 6 illustrates the distribution of para-coumaric acid in two-phases systems with glucose (A), xylose (B), and glucose+xylose (C).

FIG. 7 illustrates the distribution of ferulic acid in two-phases systems with glucose (A), xylose (B), and glucose+xylose (C).

FIG. 8 illustrates the distribution of 5-hydroxymethylfurfural (HMF) in two-phases systems with glucose (A), and xylose (B).

FIG. 9 is a schematic illustration of using a sugaring-out two phase system in the extraction of value added chemical in biomass systems.

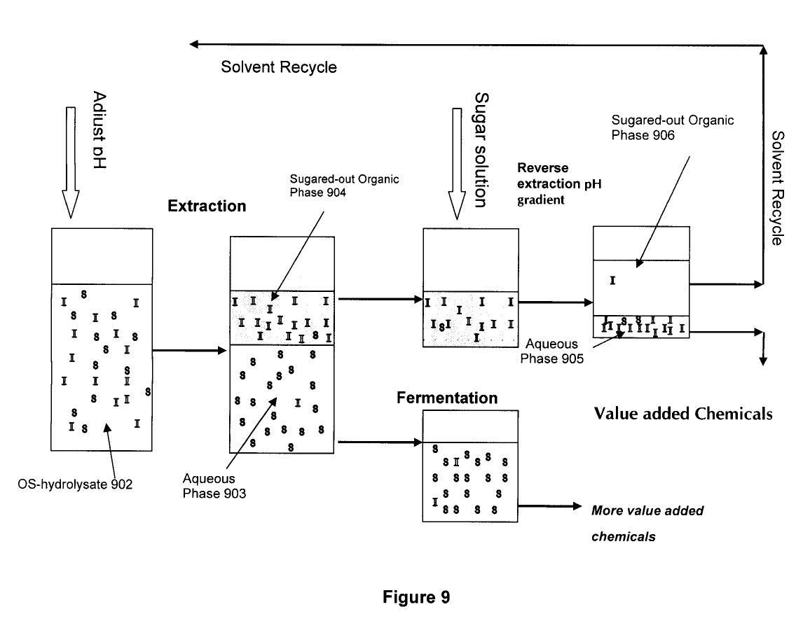

### DEFINITIONS

A “monosaccharide” is a molecule with the chemical formula (CH₂O)ₙ₊ₘ with the chemical structure H(CHOH)ₙC═O(CHOH)ₘH, where m and n are integers and m+n is at least two. If either n or m is zero, the monosaccharide comprises an aldehyde group and is termed an aldose; otherwise it comprises a ketone group and is termed a ketose. At least one-half of the non-carbonyl carbon atoms of the monosaccharide have a hydroxyl substituent. Example monosaccharides include aldotetroses such as erythrose and threose; ketotetrose such as erythrulose; aldopentoses such as arabinose, lyxose, ribose and xylose; ketopentoses such as ribulose and xylulose; aldohexoses such as allose, altrose, galactose, glucose, gulose, idose, mannose and talose; ketohexoses such as fructose, psicose, sorbose and tagatose; keto-heptoses such as mannoheptulose and sedoheptulose; octoses such as octolose and 2-keto-3-deoxy-manno-octonate; nonoses such as sialose.

An “oligosaccharide” is a polymer containing two to ten component monosaccharides. Example oligosaccharides include sucrose, lactose, maltose, trehalose and cellobiose.

A “polysaccharide” is a saccharide polymer containing more than ten component monosaccharides. Example polysaccharides include starch, cellulose and dextran.

A “saccharide” is a monosaccharide, an oligosaccharide or a polysaccharide.

A “plant phenolic” is a compound produced by a plant that has a phenolic moiety or is a derivative of a compound that includes a phenolic moiety. Usually, plant phenolics are present in plant cell walls and in organs such as leaves, flowers and fruit. Example plant phenolics include para-coumaric acid, ferulic acid, syringic acid, gallic acid, flavan-3-ols, flavonoids, flavonols, flavones, flavanones, isoflavonoids, anthocyanins, lignin precursors and lignins.

An “organic solvent” is a solvent that includes carbon. Example organic solvents include alkanes such as hexane, cyanated alkanes such as acetonitrile and propionitrile, halogenated alkanes such as methylene chlorides, oils such as vegetable oils and aromatic solvents such as benzene and toluene.

An “organic acid” is a molecule bearing a carboxylic acid moiety of formula —C(O)OH.

### DETAILED DESCRIPTION

The present invention makes use of the discovery that saccharides are capable of causing ACN to separate from its water solutions and form two-phase systems. This discovery provides methods for ACN dehydration, and extraction methods and systems. A mixture of ACN, water and a saccharide forms upper and lower phases; the upper organic phase comprises mostly ACN and small amounts of saccharide. The ACN in this “sugared-out” upper phase can reach a purity of 95.4%, which cannot be obtained by ordinary distillation.

The lower aqueous phase contains most of the saccharide. Unequal distributions of several organic species were found between the upper phase and lower phase, with most of the organic species contained in the upper phase. Accordingly, salt is no longer required in ACN-based solvent extraction systems, since one or more saccharides may be used instead, thereby minimizing equipment corrosion and fouling. Also, ACN/water extraction can now be performed without metal ions, rendering it amenable for use in systems that are intolerant to metal ions, for example biosystems.

Without being bound by any particular theory, it may be inferred that the sugaring-out phenomenon is due to the very poor solubility of saccharides in ACN. This may account for the repulsion between saccharides and ACN, which in turn causes separation of the organic and aqueous phases.

Preferred saccharides are monosaccharides and oligosaccharides that generate two phases at 0° C. from a 1:1 ACN/water mixture at a concentration of 5% wt/v. More preferred saccharides are monosaccharides and oligosaccharides that generate two phases at 0° C. from a 1:1 ACN/water mixture at a concentration of 2.5% wt/v. Most preferred saccharides are monosaccharides and oligosaccharides that generate two phases at 0° C. from a 1:1 ACN/water mixture at a concentration of 0.5% wt/v. Preferred saccharides include arabinose, lyxose, ribose, xylose, ribulose, xylulose, allose, altrose, galactose, glucose, gulose, idose, mannose, talose, fructose, psicose, sorbose, tagatose, mannoheptulose, sedoheptulose, octolose, 2-keto-3-deoxy-manno-octonate, sialose, sucrose, lactose, maltose, trehalose, cellobiose and mixtures thereof. Most preferred saccharides include glucose, xylose, arabinose, fructose, sucrose and mixtures thereof.

Sugaring-out can also be carried out with mixtures of ACN, water and optionally one or more additional organic solvents, for instance alkanes such as hexane, halogenated alkanes such as methylene chloride, and cyanated alkanes such as propionitrile. In the presence of an additional organic solvent, the organic phase may be the upper phase or the lower phase, depending on the relative quantities of ACN and the additional organic solvent. For example, an ACN, methylene chloride and water mixture will yield an organic upper phase if the ACN to methylene chloride volume ratio is sufficiently high. There can also be three separate phases coexisting, where the upper phase is sugared-out ACN, the middle phase is aqueous and the lower phase is methylene chloride. If the volume of water is too small, there will be only one phase. Accordingly, ACN can be separated from heterogeneous systems that include water and organic solvents, for example phase transfer catalysis (PTC) mixtures.

The extraction system of the present invention can be used, for example, in the bioenergy field, to extract inhibitors and by-products, for instance organic acids, plant phenolics, furfural and 5-hydroxymethylfurfural (HMT), from fermentation broths and biomass hydrolysates during the production of alcohols such as ethanol, propanol and butanol, thereby enabling continuous, uninterrupted production under milder conditions than those afforded by salting-out extraction methods. In this regard, it was found that the distribution of solutes in the saccharide/ACN/water two phase systems was also influenced by pH. For example, at a pH below 6, concentrations of plant phenolics such as para-coumaric, ferulic and syringic acids in the organic phase were high. When the pH was adjusted to values higher than 9, however, no detectable quantities of para-coumaric, ferulic and syringic acids were found in the organic phase, the compounds having re-entered the aqueous phase. Thus, at least with certain types of solutes, the addition of a pH-modifying agent such as an acid or base can increase the efficiency of the extraction system.

The milder conditions of the sugared-out extraction system are also particularly applicable to the extraction of pharmaceuticals from fermentation broths in the course of manufacturing processes, thereby removing the need for dosing the fermentation broth with acids and/or alkaline compounds and its concurrent yield losses. Since ACN has a high polarity, dielectric strength and dipole moment that render it an excellent solvent for charged organic compounds [7], the sugared-out extraction system of the present invention can be used to extract pharmaceuticals and other high-value chemicals within relatively mild pH ranges, and with potentially much less degradation and emulsification.

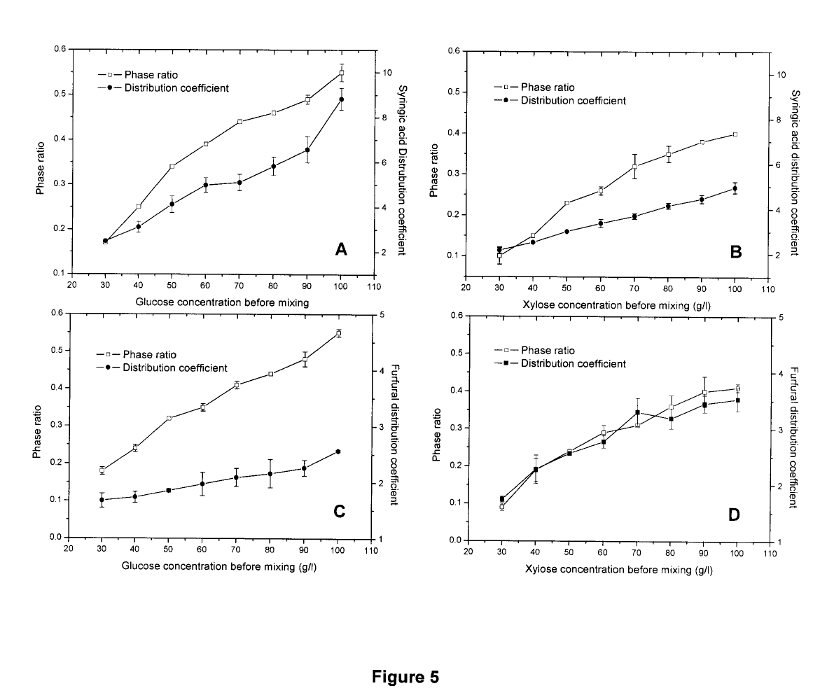

FIG. 5 illustrates an example of a sugaring-out two-phase system for the extraction of compound “I” from an aqueous phase, such as a fermentation broth. A mixture is formed by mixing ACN and optionally one or more additional organic solvents with a fermentation broth or a biomass hydrolysate 902. Optionally, the pH of 902 is adjusted in order to maximize the yield of the extraction. One or more saccharides “S” are then added, resulting in the partition of the mixture into aqueous phase 903 and sugared-out organic phase 904. Phase 904 contains most of compound “I”, whereas more hydrophilic compounds such as the saccharides “S” are retained in the aqueous phase 903. Chemical “I” is then isolated from the sugared-out organic phase. For example, 904 can be mixed with an aqueous saccharide solution and subjected to a pH change that induces compound “I” to migrate to the aqueous phase 905. The remaining organic phase 906 is then recycled. When the goal is simply to obtain ACN from an aqueous mixture containing water and ACN, one or more saccharides may be added to the mixture, causing phase separation.

### EXAMPLES

Chemicals

ACN(CH₃CN, HPLC grade), D-Glucose (C₆H₁₂O₆, Certified ACS grade), Sucrose (C₁₂H₂₂O₁₁, Certified ACS grade), D-Fructose (C₆H₁₂O₆, Certified grade), Starch ((C₆H₁₀O₅)ₙ, Certified ACS) were obtained from Fisher Scientific Company (Pittsburgh, Pa., USA). L-Arabinose (C₅H₁₀O₅, HPLC grade), Dextran Mr ˜100000 (“Dextran 100000”) and Dextran Mr˜500000 ((C₆H₁₀O₅)ₙ, Biochemika grade) (“Dextran 500000”) from Leuconostoc spp. bacteria were purchased from Sigma-Aldrich Company (St. Louis, Mo., USA). Sudan I (C₁₆H₁₂N₂O, lot number: A0214906001), D-xylose (C₅H₁₀O₅, 99%), Maltose monohydrate (C₁₂H₂₂O₁₁.H₂O, Biochemical reagent) were supplied by ACROS (New Jersey, USA), Aldrich Chemical Company (Milwaukee, Wis., USA), and Thomas Kerfoot & Co. (Vale of Bardsley, Lancashire, England) respectively.

Screening of Sugaring-out Agents

Each of the saccharides listed in Table 1 was tested for its ability to induce phase separation in ACN/water mixtures. Distilled water was combined with one of the saccharides to produce a saturated solution. The saturated solution was then mixed with ACN in capped test tubes at 1:1 v/v (volume ratio), stirred vigorously, and left to equilibrate at 25° C. for 24 hours.

Effect of Saccharide Concentration on Phase Separation

Each of the saccharides listed in Table 1 was tested for the effects of its concentration on phase separation. Water and ACN were mixed in capped test tubes at 1:1 v/v. The saccharide was separately weighed and added to the water and ACN mixtures. The resulting saccharide concentrations were from 5 g/l to 50 g/l at increments of 5 g/l, as illustrated in Table 1. The tubes were vortexed and left to equilibrate at 0° C. for 24 hours, and then examined for the formation of two clear phases. The tubes had a minimum graduation of 0.1 ml which could lead to a relative deviation of less than 1%. Samples of the upper and lower phases, each 0.2 ml to 1 ml of liquid, were taken from the tubes for high-pressure liquid chromatography (HPLC) and gas chromatography (GC) analysis. The phase ratio was defined as R=Vᵤₚₚₑᵣ/V_{lower}, where Vᵤₚₚₑᵣ was the volume of the upper phase and V_{lower} was the volume of the lower phase.

Sudan I Distribution Experiments

Sudan I was dissolved in ACN at a concentration of 1000 mg/l. Mixtures containing 5 ml of the resulting Sudan I in ACN solution and 5 ml of water were prepared, and different quantities of glucose were added to each mixture. The resulting glucose concentrations were from 5 g/l to 50 g/l with 5 g/l increments. The resulting glucose-added mixtures were stored at 0° C. for 24 hours, then samples of the upper phases were collected for later analysis.

Analysis

Sugar concentrations in the upper and lower phases were determined by HPLC analysis. The HPLC system consisted of a Waters (Milford, Mass., USA) 2695 Separation Module, a Waters 410 refractive index detector monitored by an HP Chem Station computer program (Agilent Technologies, Germany), and a Prevail Carbohydrate ES HPLC Column (250×4.6 mm, 5 μm; Alltech Associates, Inc., Deerfield, Ill., USA) equipped with a guide column (7.5×4.6 mm, 5 μm). The column temperature was kept at 30° C. The temperature of refractive index detector was also set at 30° C. The mobile phase was 75%: 25% (v/v) HPLC grade ACN and water (0.45 μm filtered) at a flow rate 1 ml/min. Standard solutions of glucose, xylose, arabinose, sucrose and fructose, with concentrations from 1.2 g/l to 24 g/l were prepared. Standard curves were plotted according to calculations and performed on the HP Chem Station. All samples were filtered through 0.4 5 μm filters into autosampler vials. Sudan I concentration was determined by absorbance measurements at 478 nm using a HP 8453 UV-Visible Spectrophotometer (Hewlett-Packard, Waldbronn, Germany). The correlation of all standard curves was found to be greater than 0.998. When necessary, samples were diluted to fit in the concentration ranges of the standard curves before analysis.

Using acetone as an internal standard, the ACN concentration in the upper phase was determined with a gas chromatographic (GC) system. C_{ACN} was defined as the concentration of ACN in the upper phases, and calculated according to Equation (1):

(1) C_{ACN}=(Weight of Acetone in std×RF*Peak area of acetonitrile×dilution factor)/Peak area of Acetone

where the RF (Response Factor) was calculated according to Equation (2):

(2) RF=(Internal std peak area/ACN peak area)/(Acetone weight in std/ACN Weight in Std)

The distribution coefficient D was defined as D=Cᵤₚₚₑᵣ/C_{lower}, where Cᵤₚₚₑᵣ is the concentration of the solute in the upper organic phase and C_{lower} is the concentration of solute in the lower aqueous phase. The extraction rate was defined as E=100×(C_{upper×V}ᵤₚₚₑᵣ)/(Cᵢₙᵢₜᵢₐₗ×Vᵢₙᵢₜᵢₐₗ), where Cᵤₚₚₑᵣ and Vᵤₚₚₑᵣ were Sudan I concentration in the upper phase and the upper phase volume, Cᵢₙᵢₜᵢₐₗ and Vᵢₙᵢₜᵢₐₗ were the solute concentration in the initial solution and the initial solution volume. All experiments above were duplicated.

Results

At 25° C., all saturated solutions of the tested monosaccharides and disaccharides, specifically glucose, xylose, arabinose, fructose, sucrose (a disaccharide of glucose and fructose) and maltose (a disaccharide of two units of glucose) can sugar out ACN from its water solution. Two clear layers, one an upper organic phase, the other an aqueous lower phase, were formed. Starch, Dextran 100000 and Dextran 500000 are complex polysaccharides composed of many glucose units. Neither of these polysaccharides induced the sugaring-out of ACN; instead, starch deposited from the ACN/water mixture, whereas Dextran 100000 and Dextran 500000 gelatinized the mixture. 5 weight/volume % of any of the tested saccharides could not sugar out the 1:1 ACN/water mixture at 25° C. However, all saccharides tested, except for starch and dextran, generated two phases at 0° C. at a concentration no higher than 3 weight/volume %. A lowering of the temperature therefore appears to favor the phase separation of the ACN/water systems.

Effect of Sugar Concentration

Saccharide concentration appears to be an important factor to the sugaring-out effect. With each saccharide, the higher the concentration, the larger the upper phase obtained (Table 1).

TABLE 1
Effect of saccharide concentration on phase separation

| | Concentration (g/l) | | | | | | | | | |
|---|---|---|---|---|---|---|---|---|---|---|
| | 5 | 10 | 15 | 20 | 25 | 30 | 35 | 40 | 45 | 50 |
| Saccharides | Phase ratio (R = Vᵤₚₚₑᵣ/V_{lower}) | | | | | | | | | |
| Glucose | — | — | — | — | 0.36 ± 0.02 | 0.39 ± 0.04 | 0.40 ± 0.02 | 0.46 ± 0.03 | 0.47 ± 0.02 | 0.51 ± 0.03 |
| Xylose | — | — | 0.08 ± 0.02 | 0.20 ± 0.04 | 0.22 ± 0.00 | 0.27 ± 0.02 | 0.28 ± 0.01 | 0.30 ± 0.04 | 0.36 ± 0.01 | 0.42 ± 0.00 |
| Arabinose | — | — | — | — | 0.21 ± 0.04 | 0.22 ± 0.01 | 0.28 ± 0.00 | 0.33 ± 0.02 | 0.36 ± 0.01 | 0.40 ± 0.03 |
| Fructose | — | — | — | — | 0.19 ± 0.03 | 0.23 ± 0.01 | 0.30 ± 0.01 | 0.36 ± 0.02 | 0.38 ± 0.00 | 0.40 ± 0.01 |
| Sucrose | — | — | — | — | — | 0.26 ± 0.03 | 0.27 ± 0.01 | 0.35 ± 0.00 | 0.38 ± 0.05 | 0.43 ± 0.03 |
| Glucose + xylose | — | — | 0.16 ± 0.02 | 0.21 ± 0.01 | 0.22 ± 0.02 | 0.28 ± 0.00 | 0.38 ± 0.01 | 0.45 ± 0.06 | 0.48 ± 0.01 | 0.48 ± 0.01 |
| mixture (1:1 wt/wt) | | | | | | | | | | |

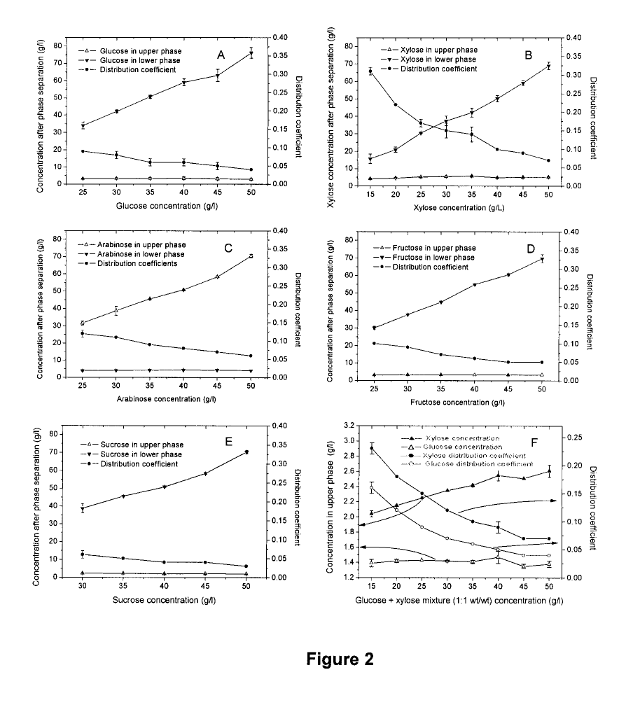

For all tested saccharides, the concentration in the upper phase was much lower than in the lower phase. Higher concentrations yielded lower distribution coefficients between the upper phase and lower phase (FIG. 2).

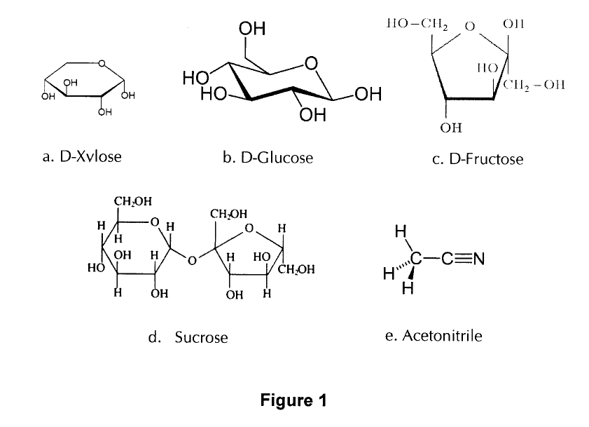

Glucose, xylose, arabinose, fructose, sucrose exhibited different sugaring-out capabilities. Mixed with identical volumes of ACN at 0° C., xylose required the least weight of saccharide (15 g/l) to sugar out ACN, while sucrose required the largest, i.e. 30 g/l to attain the sugaring-out effect. Under the same conditions, xylose was first in terms of relative saccharide distribution in the upper phase, glucose and fructose were next and sucrose was last (FIG. 2). Xylose (FIG. 1(a)) and arabinose are pentoses, glucose (FIG. 1(b)) and fructose are hexoses, while sucrose (FIG. 1(c)) is composed of glucose and fructose. Without being bound to any particular theory, it appears that the smaller the molecular size, the easier it is for the saccharide to enter the organic phase.

When a glucose and xylose mixture (1:1 wt/wt) was tested as a sugaring-out agent, possibly because of synergistic effects, the sugaring-out occurred at concentrations even lower than those required with xylose. The volume of the sugared-out upper phase was intermediate between those obtained by equal concentrations of xylose and glucose alone (Table 1). In such “glucose+xylose” mixture systems, as the total concentration of glucose and xylose increased, the upper phase concentration of xylose increased at a relatively faster rate than the glucose concentration.

Without being bound to any particular theory, the incompatibility between ACN and saccharide molecules might be the principal factor occasioning the creation of two phases and the unequal saccharide distribution. The smaller, 5-carbon xylose might have relatively better “compatibility” than the larger, 6-carbon glucose in the upper organic phase. Accordingly, because of this difference in compatibility, more ACN could enter the lower xylose solution, so the upper, ACN phase sugared-out by xylose was smaller than that sugared-out by glucose.

Effect of Saccharide Concentration on the ACN Concentration in the Upper Phase

As illustrated in Table 2, ACN concentration in the upper phase is also proportional to the saccharide concentration; higher saccharide concentrations yielded higher concentrations of ACN in the upper phase. Also, glucose appeared to yield higher ACN concentrations in the upper phase. When glucose was added at 50 g/l, the ACN concentration reached 95.4%, a purity yet unattained by ordinary distillation methods. Moreover, all the tested saccharides could sugar out ACN with a purity of more than 90%.

TABLE 2
ACN concentration (%, wt/wt) in sugared-out upper phase

| | Concentration(g/l) | | | | | | | | | |
|---|---|---|---|---|---|---|---|---|---|---|
| | 5 | 10 | 15 | 20 | 25 | 30 | 35 | 40 | 45 | 50 |
| Saccharides | ACN concentration (%, wt/wt) | | | | | | | | | |
| Glucose | — | — | — | — | 87.6 ± 1.3 | 89.0 ± 1.9 | 90.6 ± 4.2 | 91.7 ± 2.5 | 92.6 ± 6.1 | 95.4 ± 2.1 |
| Xylose | — | — | 74.5 ± 0.6 | 81.4 ± 1.8 | 84.6 ± 2.5 | 84.5 ± 3.8 | 87.7 ± 4.5 | 92.6 ± 4.3 | 90.1 ± 2.2 | 90.9 ± 3.2 |
| Arabinose | — | — | — | — | 91.1 ± 5.7 | 90.1 ± 4.3 | 94.2 ± 1.3 | 94.9 ± 5.0 | 92.4 ± 6.3 | 89.8 ± 5.4 |
| Fructose | — | — | — | — | 81.4 ± 3.7 | 80.7 ± 5.0 | 82.2 ± 3.3 | 85.2 ± 6.0 | 87.0 ± 4.1 | 89.1 ± 5.1 |
| Sucrose | — | — | — | — | — | 81.7 ± 3.8 | 84.9 ± 8.0 | 85.4 ± 7.8 | 87.0 ± 6.5 | 90.4 ± 6.2 |
| Glucose + xylose | — | — | 81.2 ± 4.0 | 84.7 ± 5.5 | 83.4 ± 2.1 | 81.3 ± 0.7 | 83.1 ± 3.6 | 84.5 ± 7.0 | 88.3 ± 7.6 | 94.9 ± 3.1 |
| mixture (1:1 wt/wt) | | | | | | | | | | |

Sudan I Distribution Based on the Sugaring-out System

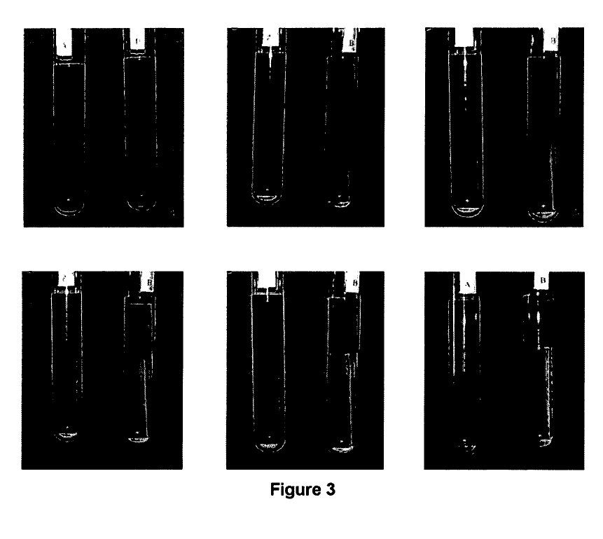

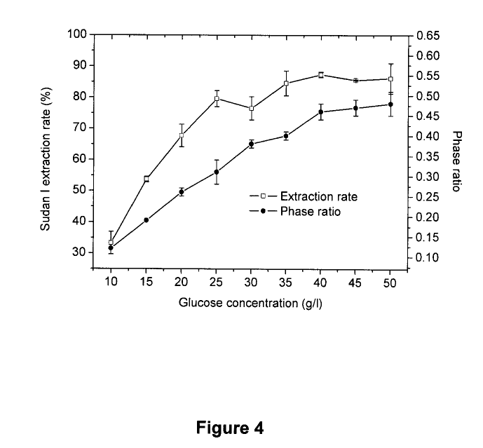

The extraction capabilities of sugaring-out systems was confirmed by the unequal distribution of Sudan I between the upper phase and lower phase, as illustrated in FIG. 3. In FIG. 3.1, Sudan I distributed evenly between tube A (left) and B (right). After dissolving 2.5% (wt/v) glucose in tube A and 5% (wt/v) glucose in tube B, the system turned opaque, an emulsion-like layer having formed in the solution (FIG. 3.2). The emulsion-like layer then decreased, while a separate upper phase and lower phase formed. The upper phase turned darker and the lower became transparent, but the interface was not yet visible (FIG. 3.3; FIG. 3.4). Three minutes after the addition of the saccharides, a clear interface appeared in tube B, but some blurring between the phases persisted in tube A (FIG. 3.5). At five minutes from the addition of the saccharides, two completely separate phases were formed in both tubes (FIG. 3.6). Sudan I extraction rates obtained at different glucose concentrations are plotted in FIG. 4.

Distribution of Compounds Based on the Sugaring-Out System

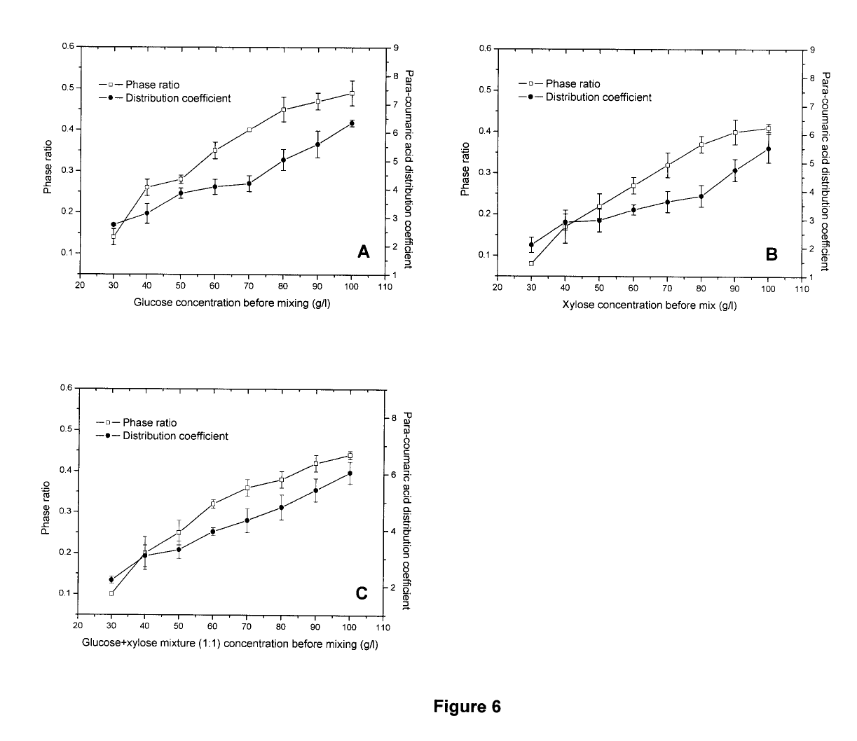

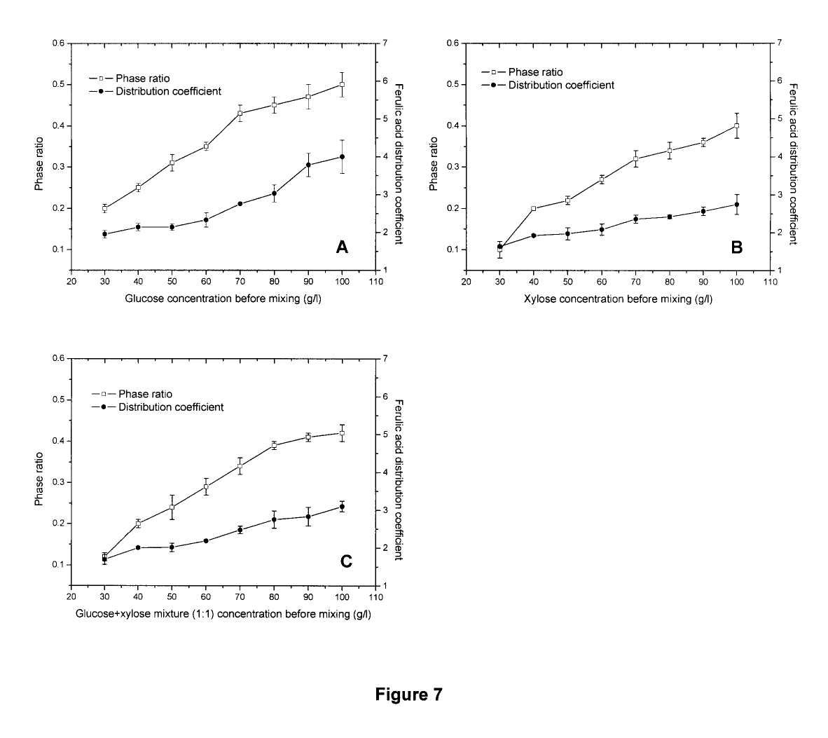

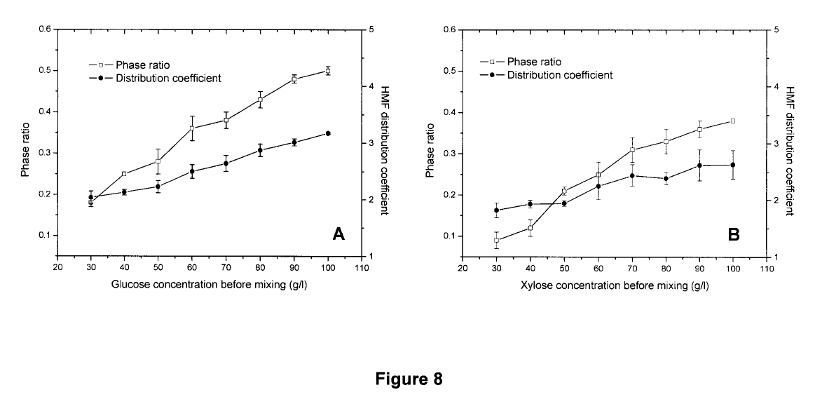

The unequal distribution of syringic acid, furfural, para-coumaric acid, ferulic acid and 5-Hydroxymethyl furfural in the two phases was also investigated. Their concentrations in upper phases were much higher than those in lower phases (FIGS. 5-8).

### REFERENCES

[1] Chung N H, Tabata M, 2002, Talanta 58: 927-933.
[2] Frankforter G B, Cohen L, 1914, J. Am. Chem. Soc. 36: 1103-1134.
[3] Frankforter G B, Fray F C, 1913, J. Phys. Chem. 17: 402-473.
[4] Frankforter G B, Temple S, 1915, J. Am. Chem. Soc. 37: 2697-2716.
[5] Jones L A, Prabel G B, Glennon J J, Copeland M F, Kavlock R J, 1993, J. Agric. Food Chem. 41: 735-741.
[6] Kobe K A, Stone J P, 1940, J. Phys. Chem. 446: 629-633.
[7] Kroschwitz J I, Howe-Grant M, 1998, Encyclopedia of the chemical technology: supplement volume: aerogels to xylylene polymers. New York: Wiley.
[8] Leggett D C, Jenkins T F, Miyares P H, 1990, Anal. Chem. 62: 1355-1356.
[9] Leinonen H, 1996, Corrosion 52: 337-346.
[10] Lu X, Han P, Zhang Y, Wang Y, Shi J, 2000, Chem. Eng. J. 78: 165-171.
[11] Nishihama N, Hirai T, Komasawa I, 2001, Ind. Eng. Chem. Res. 40: 3085-3091.
[12] Rydberg J, Musikas C, Choppin G R, 1992, Principles and practices of solvent extraction. New York: M. Dekker.
[13] Schenk F J, Callery P, Cannett PM, Draft J R, Lehotay S J, 2002, J. AOAC Int. 85: 1177-1180.
[14] Singleton V L, 1961, Am. J. Enol. Vitic. 12: 1-8.
[15] U.S. Pat. No. 6,159,347.
[16] Tabata M, Kumamoto M, Nishimoto J, 1994, Anal. Sci. 10: 383-388.
[17] Tabata M, Kumamoto M, Nishimoto J, 1996, Anal. Chem. 68: 758-762.
[18] Thornton J D, 1992. Science and practice of liquid-liquid extraction (II): process chemistry and extraction operations in the hydrometallurgical, nuclear, pharmaceutical, and food industries. Oxford: Clarendon Press.
[19] Van der Wal Sj., 1985, Chromatographia 20: 274-278.
[20] Wang B., 2000, Investigation on emulsification and demulsification during penicillin extraction. Doctoral dissertation. The Chinese Academy of Sciences.
[21] Warren K W, 1995, Reduction of corrosion through improvements in desalting. Benelux Refinery Symposium, Lanaken, Belgium.
[22] Wu Y G, Tabata M, Takamuku T, Yamaguchi A, Kawaguchi T, Chung N H, 2001, Fluid Phase Equilib. 192: 1-12.
[23] Siva Rama Rao C V, Venkateswara Rao K, Raviprasad A, Chiranjivi C., 1978, J. Chem. Eng. Data. 23: 23-25.
[24] Gould R F., 1972, Extractive and Azeotropic Distillation. Advances in Chemistry Series. No. 115. Washington: American Chemical Society.
[25] Horsley L H, 1911, Azeotropic Data-Ill. Advances in Chemistry Series. No. 116. American Chemical Society, Washington D.C.
[26] U.S. Pat. No. 4,362,603.
[27] U.S. Pat. No. 6,326,508.
[28] U.S. Pat. No. 6,843,890.
[291] Kester H Z., 1992, Distillation Design. McGraw-Hill, Inc., New York, N.Y.
[30] Subba Rao D, Venkateswara Rao K, Ravi Prasad A, Chiranjivi C, 1979, Extraction of acetonitrile from aqueous solutions. 2. ternary liquid equilibria. J. Chem. Eng. Data. 24: 241-244.
[31] Ginnings P M, Robbins D, 1930, Ternary systems: water, tertiary butanol and salts at 30° C., J. Am. Chem. Soc. 52: 2282-2286.
[32] Long F A, McDevit W F, 1952, Chem. Rev. 51: 119-169.
[33] Pierotti R A, 1976, Chem. Rev. 76: 717-726.
[34] Buell P, Girard, 2003, Chemistry Fundamentals: An Environmental Perspective. Sudbury, Mass.: Jones & Bartlett.
[35] Lazarova Z, Peeva L, 1994, 32:75-82.
[36] Likidis Z, Schügerl K, 1987, Biotechnology Letters 9: 229-232.
[37] Mateles R I, 1998, Penicillin: a paradigm for biotechnology. Chicago: Candida Corp.
[38] Qiang Z, Adams C, 2004, Water Research 38: 2874-2890.
[39] Morrison and Boyd. 1973. Organic Chemistry. Boston
[40] Schügerl K, 1994, Solvent extraction in biotechnology: recovery of primary and secondary metabolites. Verlag Berlin Heidelberg: Speinger.

1. An extraction system comprising:
acetonitrile,
water, and
a saccharide selected from the group consisting of a monosaccharide, an oligosaccharide, and mixtures thereof,
wherein the system comprises a first phase and a second phase, and a concentration of the saccharide is at least 0.5 weight/volume %.

2. The extraction system of claim 1, wherein the saccharide is selected from the group consisting of arabinose, lyxose, ribose, xylose, ribulose, xylulose, allose, altrose, galactose, glucose, gulose, idose, mannose, talose, fructose, psicose, sorbose, tagatose, mannoheptulose, sedoheptulose, octolose, 2-keto-3-deoxy-manno-octonate, sialose, sucrose, lactose, maltose, trehalose, cellobiose, and mixtures thereof.

3. The extraction system of claim 1, wherein the saccharide is selected from the group consisting of glucose, xylose, arabinose, fructose, sucrose, and mixtures thereof.

4. The extraction system of claim 1, wherein the saccharide is a monosaccharide.

5. The extraction system of claim 1, wherein the saccharide is an oligosaccharide.

6. The extraction system of claim 1, further comprising an additional organic solvent which is not acetonitrile.

7. The extraction system of claim 1, further comprising an additional organic solvent which is not acetonitrile selected from the group consisting of alkanes, halogenated alkanes, cyanated alkanes, vegetable oils, aromatic solvents, and mixtures thereof.

8. The extraction system of claim 1, further comprising an additional organic solvent selected from the group consisting of methylene chloride, propionitrile, and mixtures thereof.

9. A method of separating acetonitrile from water, comprising:
adding a saccharide to a mixture comprising acetonitrile and water,
wherein the saccharide is selected from the group consisting of a monosaccharide, an oligosaccharide, and mixtures thereof, and a concentration of the saccharide is at least 0.5 weight/volume %.

10. The method of claim 9, wherein the saccharide is selected from the group consisting of arabinose, lyxose, ribose, xylose, ribulose, xylulose, allose, altrose, galactose, glucose, gulose, idose, mannose, talose, fructose, psicose, sorbose, tagatose, mannoheptulose, sedoheptulose, octolose, 2-keto-3-deoxy-manno-octonate, sialose, sucrose, lactose, maltose, trehalose, cellobiose, and mixtures thereof.

11. The method of claim 9, wherein the saccharide is a monosaccharide.

12. The method of claim 9, wherein the saccharide is an oligosaccharide.

13. The method of claim 9, wherein the saccharide is selected from the group consisting of glucose, xylose, arabinose, fructose, sucrose, and mixtures thereof.

14. The method of claim 9, wherein the mixture further comprises an additional organic solvent which is not acetonitrile.

15. The method of claim 9, wherein the mixture further comprises an additional organic solvent which is not acetonitrile selected from the group consisting of alkanes, halogenated alkanes, cyanated alkanes, vegetable oils, aromatic solvents, and mixtures thereof.

16. The method of claim 9, wherein the mixture further comprises an additional organic solvent selected from the group consisting of methylene chloride, propionitrile, and mixtures thereof.

17. (canceled)

18. A method of extracting a compound from an aqueous solution,
comprising: adding acetonitrile and a saccharide to the solution,
wherein the saccharide is selected from the group consisting of a monosaccharide, an oligosaccharide and mixtures thereof, and a concentration of the saccharide is at least 0.5 weight/volume %.

19-32. (canceled)

33. An extraction system, comprising:
acetonitrile,
water,
optionally salt, and
a saccharide selected from the group consisting of a monosaccharide, an
oligosaccharide, and mixtures thereof,
wherein the system comprises a first phase and a second phase, and
an amount of the salt is insufficient to cause phase separation of a composition consisting of the acetonitrile, the water and the salt.

34. A method of separating acetonitrile from water, comprising:
adding a saccharide to a mixture comprising acetonitrile, water and optionally salt,
wherein the saccharide is selected from the group consisting of a monosaccharide, an oligosaccharide, and mixtures thereof, and an amount of the salt is insufficient to cause phase separation of a composition consisting of the acetonitrile, the water and the salt.

35. A method of extracting a compound from an aqueous solution optionally comprising salt, the method comprising: adding acetonitrile and a saccharide to the solution,
wherein the saccharide is selected from the group consisting of a monosaccharide, an oligosaccharide, and mixtures thereof, and an amount of the salt is insufficient to cause phase separation of a composition consisting of the acetonitrile, the water and the salt.
